(19) United States
(12) Patent Application Publication
(10) Pub. No.: US 2026/0102858 A1
(43) Pub. Date: Apr. 16, 2026

(54) AUTOMATED TROLLEY SYSTEM FOR TIGHTENING TOWER SEGMENTS IN WIND TURBINES

(71) Applicant: HYTORC Division UNEX Corporation, Mahwah, NJ (US)

(72) Inventors: Eric P. Junkers, Mahwah, NJ (US); Ulrich Oehms, Sprockhovel (DE); Joachim Santen, Sprockhovel (DE); Ingo Muller, Sprockhovel (DE)

(73) Assignee: HYTORC Division UNEX Corporation, Mahwah, NJ (US)

(21) Appl. No.: 19/115,443

(22) PCT Filed: Sep. 26, 2023
(86) PCT No.: PCT/US23/33740

§ 371 Date: Mar. 26, 2025

Related U.S. Application Data
(60) Provisional application No. 63/410,190, filed on Sep. 26, 2022.

(51) Int. Cl. B23P 6/00; B25J 5/00

(52) U.S. Cl. CPC B23P 6/002; B25J 5/00

(57) ABSTRACT

An automated trolley system for wind turbine tower segment tightening is presented. The system consists of a body with first and second portions at either end, with the first portion mounting close to bolts and driving on top of a flange while being guided by wheels, and the second portion pushing against the interior of the tower through wheels to move the body around a flange in order to automatically tighten the flange. The system includes at least one wrench socket with or without an internal pattern attached to a plate, and each wrench socket is designed to use electric or hydraulic torquing and/or tensioning to tighten each bolt that is placed on top rather than the bottom. The system comprises a winch with a balancer adapted to screwing the wrench socket with or without internal pattern.

### BACKGROUND

### Field of Invention

The present invention generally relates to wind turbine tower segment construction system, and more particularly, to an automated trolley system and method for tightening tower segments in wind turbine.

### Description of Related Art

The wind power industry, which is rapidly growing as a part of the development of renewable energies, has gradually advanced in quest of higher cost-effectiveness, which has led to the design of increasingly more potent wind turbines. Towers for wind turbines are frequently built out of various vertical parts to make handling and transit easier.

Typically, each section consists of conical-shaped steel exterior walls that have been rolled from steel sheet stock and joined together by welding. The conical tower parts'top and lower ends can each be welded to an annular flange that has been machined. The wind turbine tower may be built using a variety of various methods, such as concrete, latticework, or tubular steel.

During the lifting of the tower segments of wind turbines, the screws are first inserted into the flange from above and then turned around to tighten. This work step is necessary because there is currently no way to safely insert tools weighing more than 30 kg from below.

The setting up of offshore wind turbines is essential. Weather windows where the weather permits wind turbine assembly at sea are needed for off-shore wind turbine construction.

Therefore, a trolley system is required with the technical setup that results in repeatable, quick, and precise bolting procedures, which considerably shortens expensive maintenance periods on onshore and, especially, offshore wind turbines.

### SUMMARY

One goal of the current innovation is to significantly reduce time spent “turning screws”by the use of an alternative method.

Offering worker relief with only approximately 100 N of manual power is another goal of the current technology.

Another object of the present invention aims to provide maximum work safety and can also be operated by just one worker.

Another goal of the current invention is quick, fatigue-free operations with various screw sizes and tools.

Another goal of the current invention is a trolley system which travels around the flange from the top and guides one or more tools under the flange.

According to an embodiment of the present invention provide a trolley system for automatically tightening tower segments in wind turbine. The system comprising a body with a first portion and a second portion at either end, the first portion mounting close to bolts and driving on top of a flange while being guided by wheels, the second portion pushing against the interior of the tower through wheels to move the body around a flange to automatically tighten the flange. The system comprising at least one wrench socket with or without internal pattern attached to a plate and each of the wrench socket is configured to tighten each bolt placed on top rather than the bottom through electric or hydraulic torquing and/or tensioning. The system includes a winch with a balancer configured to screwing the wrench socket with or without internal pattern for fastening each bolt to the nut, further a small fraction of elastic deformation is recovered after torque screwing as a portion of the torsion recovers. The method also includes a lever assembly while using springs move up and down with negligible manual force and moved from one bolt to next bolt. The system also includes a generator configured to provide electric power for rotating the wrench socket for tightening the bolts through electric or hydraulic torquing and/or tensioning.

In one embodiment of the present invention, a torque-to-angle of rotation ratio is continuously monitored by a pump connected to the generator, when the gradient falls beyond the acceptable range, the pump shuts off.

One of the wrench sockets 106 in this instance has an internal pattern and is situated in the center of the plate 114. In the event that the bolt 118 is circular, the other two wrench sockets 106 are patternless.

Embodiments in accordance with the present invention provide method for automatically tightening tower segments in wind turbine. The method comprising configuring a body with a first portion and a second portion at either end, the first portion mounting close to bolts and driving on top of a flange while being guided by wheels, the second portion pushing against the interior of the tower through wheels to move the body around the flange to automatically tighten the flange. The method also includes attaching at least one wrench socket with or without internal pattern to a plate and each of the wrench socket is configured to tighten each bolt placed on top rather than the bottom through electric or hydraulic torquing and/or tensioning. The method also includes configuring a winch with a balancer to screwing the wrench socket with or without internal pattern for fastening each bolt to the nut, further a small fraction of elastic deformation is recovered after torque screwing as a portion of the torsion recovers. The method also includes moving a lever assembly while using springs up and down with negligible manual force and moving the trolley system from one bolt to next bolt. The method also includes associating a generator to provide electric power for rotating the wrench socket for tightening the bolts through electric or hydraulic torquing and/or tensioning.

In one embodiment of the present invention, the wheels connected to the second portion of the body move in conjunction with the wheels attached to the first portion of the body.

In one embodiment of the present invention, a handling component may be affixed to the rear of the third portion of the body to apply additional physical force for simple movement of the trolley system around the tower segment for bolt tightening.

In one embodiment of the present invention, the center of gravity of the trolley system is below the flange.

According to an embodiment of the present invention, the weight of the trolley system being safely guided to the top of the flange.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a side view of the trolley system for automatically tightening tower segments in wind turbine, according to embodiments of the present invention disclosed herein;

FIG. 1B illustrates a front side view of the trolley system for automatically tightening tower segments in a wind turbine, according to embodiments of the present invention disclosed herein;

FIG. 1C illustrates a bottom view of the trolley system for automatically tightening the tower segments in the wind turbine, according to embodiments of the present invention disclosed herein;

FIG. 1D illustrates a top view of the trolley system for automatically tightening the tower segments in the wind turbine, according to embodiments of the present invention disclosed herein;

FIG. 1E illustrates a side view of the trolley system engaged with the tower segments, according to embodiments of the present invention disclosed herein; and

FIG. 1F illustrates a top view of the trolley system engaged with the tower segments, according to embodiments of the present invention disclosed herein.

FIG. 2 illustrates a flowchart of a method for automatically tightening tower segments in wind turbine, according to embodiments of the present invention disclosed herein.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

A plurality of large wind turbines are provided with tubular steel towers, which are made in sections of 20-30 meters, have flanges on both ends, and are bolted together on the work area. In order to maximize strength and conserve materials at the same time, the towers are conical, meaning that the diameter increases toward the base.

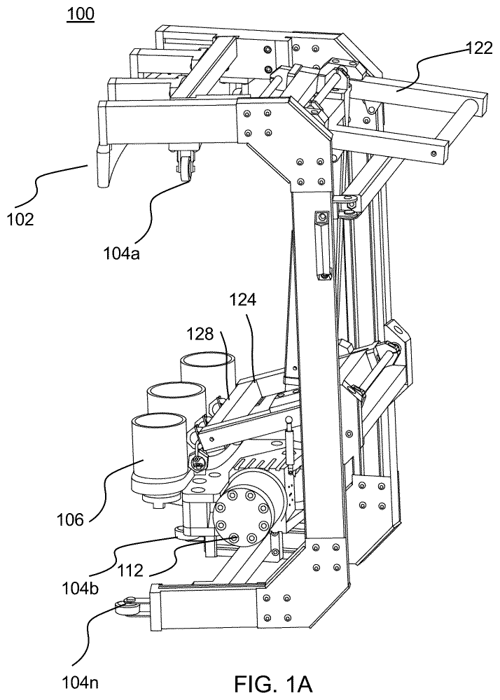

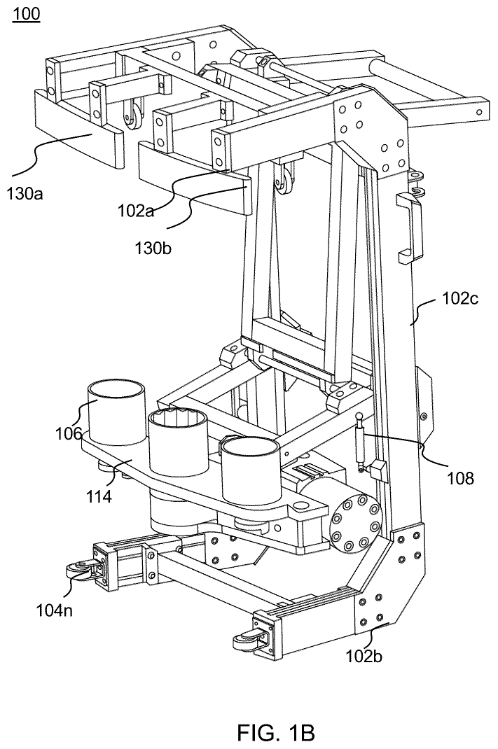

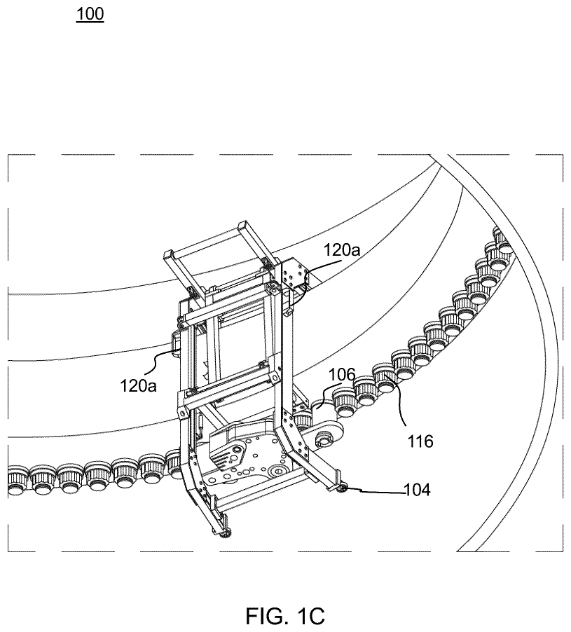

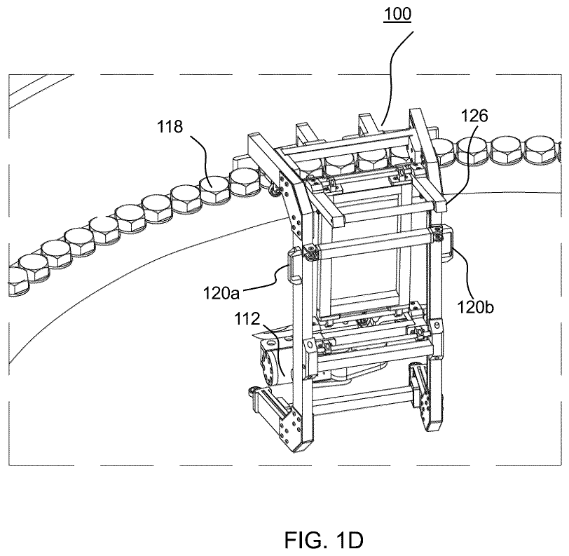

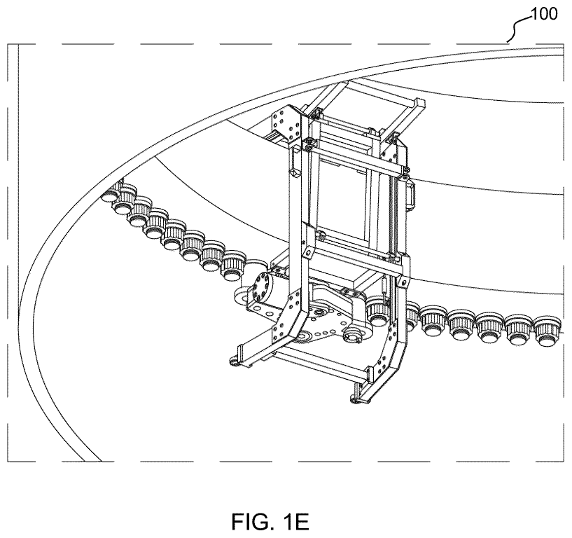

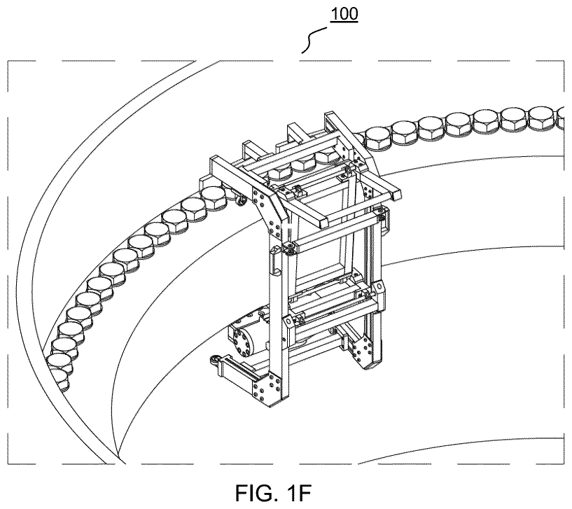

FIG. 1A illustrates a side view of the trolley system 100 for automatically tightening tower segments in wind turbine. The trolley system 100 comprises a body 102, wheels 104a-104n (hereinafter referred to as wheels 104), at least one wrench socket 106, a winch with a balancer, a lever assembly, springs 108, a generator 110, a pump, and so forth.

A tower holds a nacelle and rotor blades up in the wind and provides access to nacelle. The tower comprises shell segment, nuts 116 and bolts 118, and so forth. Each bolt 118 is associated with a tower section being subdivided into two or more associated elongated shell segments, which associated shell segments are adapted to combine into a complete tower section.

Further, each of the shell segments is provided with vertical and horizontal angle edges having a number of through holes for interconnecting the segments by means of e.g. bolts.

According to embodiments of the present invention, the trolley system 100 comprises the body 102 that may be further divided into portions. The body 102 may comprise a first portion 102a and a second portion 102b at either end. The first portion 102a may be mounting close to bolts 118 and driving on top of a flange while being guided by wheels 104.

For simple movement of the trolley system 100 around the tower segment that needs to be connected, the wheels 104 may be mounted to the first portion 102a in a vertical position.

Further, the body 102 comprises the second portion 102b that may be pushing against the interior of the tower through wheels 104 to move the body 102 around a flange to automatically tighten the flange.

The second portion 102b of the body 102, which is located at the base of the trolley system 100, may be fitted with wheels 104 so as to move in conjunction with the wheels 104 attached to the first portion 102a of the body 102, which is located at the top of the trolley system 100.

The trolley system 100 may include two or more handles that are fastened to a third component 102c of the trolley system 100's body. The left side of the third portion 102c is where one handle 120a is fastened, and the right side is where handle 120b is attached. It is possible to move the trolley system 100 to a different set of bolts 118 for electric or hydraulic tension tightening by using the handles 120a and 120b while exerting manual force.

In addition, a handling component 122 may be affixed to the rear of the third portion 102c of the body to apply additional physical force for simple movement of the trolley system 100 around the tower segment for bolt 118 tightening.

The trolley system 100 may have two supporting components 124, 126 attached to the third portion 102c of the body 102. Using chains 128, a first supporting component 124 may be connected to the wrench socket 106. To prevent the nut 114 from moving or slipping during the tightening process, the first supporting component 124 may be further engaged with the nuts 114. To further minimise slippage during screwing, the second supporting component 126 may be engaged with the bolt's head.

The trolley system 100 might include the generator 112 that initiates and terminates the movement of the wrench socket 106 during the process of being tightened or loosened.

FIG. 1B illustrates a front side view of the trolley system 100 for automatically tightening tower segments in the wind turbine, according to embodiments of the present invention. The first portion 102a that engages with the bolt 118 is clearly visible in FIG. 1B.

While the second supporting component 126, as seen in FIG. 1D, may be engaged to the front of the bolt 118, the first portion 102a has at least two support elements 130a, 130b that are shifted to the back of the bolt 118. One of the wrench sockets 106 in this instance has an internal pattern and is situated in the center of the plate 114. In the event that the bolt 118 is circular, the other two wrench sockets 106 are patternless.

The first supporting component 124 connected to the third portion 102c of the body 102 may be engaged with the spring 108 in one embodiment of the present invention. The first supporting element 124 engages the wrench socket 106 using the spring's movement, as indicated in FIG. FIGS. 1C and 1D.

In one implementation of the invention, the first supporting component 124 makes use of the spring's 108 movement to disengage the wrench socket 106.

In addition, the body 102 could be created by screwing together the first portion 102a at the top with the third portion 102c in the middle and the third portion 102c with the second portion 102b at the base, as shown in FIG. 1B.

FIG. 1C illustrates a bottom view of the trolley system for automatically tightening the tower segments in the wind turbine, according to embodiments of the present invention. The weight of the trolley system 100 being safely guided to the top of the flange.

Additionally, the trolley system 100 is built in such a way that as much surface as possible is covered by the flanges, which vary in thickness, breadth, number of bolts, and bolt dimension.

The movement of the spring 108 causes the first supporting element 124, which engages the wrench socket 106. For loosening, the wrench socket 106 may rotate counter clockwise in order to disengage from the nut 116.

To engage the wrench socket 106 to the nut 116 and tighten it, the wrench socket 106 in one embodiment of the invention may rotate clockwise.

However, the center of gravity of the trolley system 100 is below the flange. The trolley system 100 may be adjusted to the size of an operator and the distance between a work platform and the flange.

FIG. 1D illustrates a top view of the trolley system for automatically tightening the tower segments in the wind turbine, according to embodiments of the present invention. The trolley system 100 may be equipped with two or more handles that are attached to a third component 102c of the body 102 of the trolley system 100. One handle 120a and one handle 120b are attached to the third component 102c's left and right sides, respectively. Using the handles 120a and 120b while applying manual force, the trolley system 100 can be moved to a different set of bolts for electric or hydraulic tension tightening.

Additionally, a handling component 122 may be attached to the back of the third portion 102c of the body to add extra physical force for easy movement of the trolley system 100 around the tower segment for bolt 118 tightening.

The second supporting component 126 may be positioned against the bolt head to reduce slippage even further during screwing.

FIG. 1E illustrates a side view of the trolley system engaged with the tower segments, according to embodiments of the present invention. The generator 112, which is a component of the trolley system 100, starts and stops the movement of the wrench socket 106 as the nuts are tightened or loosened. The first supporting component 124 may be further engaged with the nuts 114 to keep them from sliding or moving while being tightened.

FIG. 1F illustrates a top view of the trolley system engaged with the tower segments, according to embodiments of the present invention. Using the wheels 104, the trolley system 100 may be moved to the left side of the tower segment where the bolts are to be screwed. To move the body 102 around a flange of the tower segment, the body also includes the second section 102b that may be pressing against the inside of the tower through wheels 104. Together with the wheels 104 attached to the body's first portion 102a, the wheels 104 connected to the body's second portion 102b move the trolley system 100.

The trolley system 100 further comprises a third portion 102c of the body 102 including a center of mass of trolley system, a mediated center of mass, a position of the bolts for hanging on a tower crane, or any foregoing combination. In an embodiment of the present invention, the third portion 102c of the body 102 is interlocked with the first and second portions of the body 102. Further, the trolley system 100 needs to be entirely disconnected from the reaction forces of the trolley system 100 in order to be used on the flange.

The wrench socket 106 with or without internal pattern attached to a plate 114 and each of the wrench socket 106 may be configured to tighten each bolt 118 placed on top rather than the bottom through electric or hydraulic torquing and/or tensioning.

The bolts from above by using at least two chains 128 to join the wrench socket 106 to the trolley system 100. Further, the trolley system 100 is built so compactly that the system 100 fits through all hatches.

According to embodiments of the present invention, the trolley system 100 may be designed in such a way that partial or full automation is possible and the function of the trolley system 100 being optimally coordinated through the use of gas springs 108 and the right choice of articulation points The winch with a balancer may be configured to screwing the wrench socket 106 with or without internal pattern for fastening each bolt 118 to the nut 116, further a small fraction of elastic deformation is recovered after torque screwing as a portion of the torsion recovers.

According to embodiments of the present invention, the lever assembly while using springs 108 move up and down with negligible manual force and moved from one bolt to next bolt. The generator 110 may be configured to provide electric power for rotating the wrench socket 106 for tightening the bolts 118 through electric or hydraulic torquing and/or tensioning.

A torque-to-angle of rotation ratio is continuously monitored by a pump connected to the generator, when the gradient falls beyond the acceptable range, the pump shuts off.

An elastic and plastic areas of the wrench socket are reached when the torque is increased and the wrench socket 106 generates larger rotation angles, a delta between zero measurement before and after the tightening/loosening process has a minimal elongation, the detection of bolts is relatively straightforward.

Conical tower sections can be connected to other conical tower sections by means of the flanges at each end, which may feature apertures for threaded fasteners.

The flanges might include features to mount the tower sections to one another and lend rigidity to the conically shaped walls. These features, in many implementations, include several apertures that line up with apertures in a corresponding flange of a matching tower section to permit fasteners to pass therethrough, joining the flanges to one another.

One implementation of the invention does not require a counter holder since the bolt head is adjusted. By adjusting the bolt head, individuals may reduce the breadth of the wrench, which in turn reduces the size of the corresponding bolt. This allows individuals to push the partial circle further towards the outside wall and add more bolts as a result.

The trolley system 100 is adapted to any of the flange diameters and sizes. the trolley system comprises a conical alignment pin at 12 and 6 o'clock for allowing easy alignment of the trolley system.

Since the rotating operation does not require support like the pulling process does, there is no harm to the painted or maintained flange surfaces. A coating layer between the washer and the flange surface has no adverse effects, regardless of the coating procedure used, according to a state-funded study in the field of lightweight construction. When the screws/bolts 118 are installed top to bottom, moisture cannot condense there, unlike when they are installed bottom to top.

In a threaded area the nut may be already clearly seen, so the fundamental idea of observing that the bolt has fallen out of the flange may be ignored. Software may fix various issues with a flange gap closure. The twelve point bolt and washers were preloaded with a minimum 70% preload force and torque. Due to the angle of rotation, a counter holder is employed.

The need for a trolley system 100 may be brought on by the high torques and the heavy tools that go along with them. Utilizing the 12 pt nut allowed for a substantial improvement in the power tightness of the tower flange. It was still necessary to create and build a tightening and counter-holding system, though. The user may achieve better results more quickly if the manufacturer (GE), the screw supplier, and the tool provider cooperate from the start to optimise flange fitting.

Preload force at the flange is increased by adding more screws with more preload force. Screwing from below means no more exhausting screw turning. Due to the improved head design, there is no screw rotation, improved shaft design increases fatigue strength. Discs are eliminated as they are incorporated into the head or the nut. BIM elimination because of trustworthy pretensioning to over 90% and 100% documentation.

Due to an enhanced screwdriving procedure, there is no masking of the screw tips. At this point, we demonstrate the “new screw” and the corresponding tool with a trolley and the ideal screwdriving technique for this application.

A side view of the trolley system attached to tower segments is shown in FIG. 1E in accordance with implementations of the present invention. To tighten the bolt using electric or hydraulic tension, the wrench socket is engaged with the nuts. In addition, torque tightening is the precise application of torque to the nut in order to let the bolt to securely retain its load without snapping.

The portion 102a engages the body and makes it easier for the trolley system to move while tightening the next bolt, as seen in FIG. 1F.

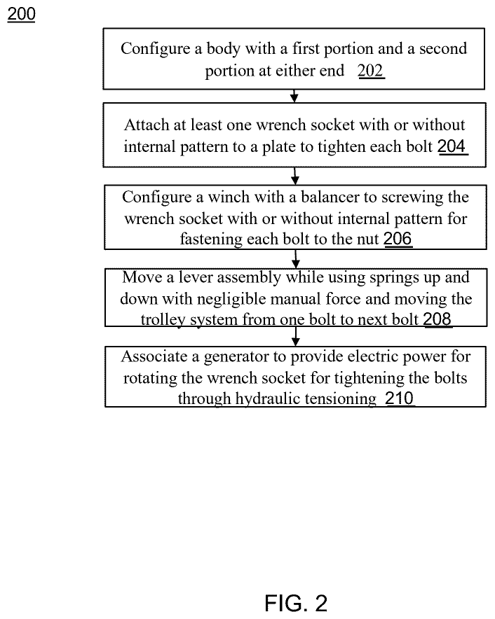

FIG. 2 illustrates a flowchart of a method 200 for automatically tightening tower segments in wind turbine, according to embodiments of the present invention.

At 202, configuring the 102 body with the first portion 102a and a second portion 102b at either end. The first portion 102a may be mounting close to bolts and driving on top of a flange while being guided by wheels. The second portion 102b may be pushing against the interior of the tower through wheels 104 to move the body 102 around the flange to automatically tighten the flange.

At 204, attaching at least one wrench socket 106 with or without internal pattern to the plate 114 and each of the wrench socket 106 is configured to tighten each bolt placed on top rather than the bottom through electric or hydraulic torquing and/or tensioning.

At 206, configuring the winch with a balancer to screwing the wrench socket 106 with or without internal pattern for fastening each bolt to the nut, further a small fraction of elastic deformation is recovered after torque screwing as a portion of the torsion recovers.

At 208, moving the lever assembly while using springs 108 up and down with negligible manual force and moving the trolley system from one bolt to next bolt.

At 210, associating the generator 112 to provide electric power for rotating the wrench socket 106 for tightening the bolts through electric or hydraulic torquing and/or tensioning.

While the embodiments of FIGS. 1 and 2 have been described in connection with electric or hydraulic torque tools and pumps, it is to be understood that manual, electric, pneumatic and/or hydraulic torque and/or tension tools could also be used. In such various modifications and/or such equivalent arrangements, the power generator may be manual, electric, pneumatic and/or hydraulic in nature. Furthermore, rather than just using a pump to monitor the bolting process, a sensor connected to the generator could be used. Also, two or more tools may be used with other variations of the system. Note that the reaction cups would not be needed when applying the multiple tool option.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

What is claimed is:

1. A trolley system for automatically tightening tower segments in wind turbine, the system comprising:
a body with a first portion and a second portion at either end, the first portion mounting close to bolts and driving on top of a flange while being guided by wheels, the second portion pushing against the interior of the tower through wheels to move the body around a flange to automatically tighten the flange;
at least one wrench socket with or without internal pattern attached to a plate and each of the wrench socket is configured to tighten each bolt placed on top rather than the bottom through torquing and/or tensioning;
a winch with a balancer configured to screwing the wrench socket with or without internal pattern for fastening each bolt to the nut, further a small fraction of elastic deformation is recovered after torque screwing as a portion of the torsion recovers;
a lever assembly while using springs move up and down with negligible manual force and moved from one bolt to next bolt;
a generator configured to provide power for rotating the wrench socket for tightening the bolts through torquing and/or tensioning; and
wherein a torque-to-angle of rotation ratio is continuously monitored by a sensor connected to the generator, when the gradient falls beyond the acceptable range, the generator shuts off.

2. The system of claim 1, wherein the generator is one of manual, electric, pneumatic and/or hydraulic in nature.

3. The system of claim 1, wherein the generator is an hydraulic pump.

4. The system of claim 1, wherein when the bolts are inserted into a flange from above and then rotated around to tighten into the bolt, each of the bolts engages with a nut associated with the tower section.

5. The system of claim 1, wherein the weight of the trolley system being safely guided to the top of the flange.

6. The system of claim 1, wherein the trolley system is built in such a way that as much surface as possible is covered by the flanges, which vary in thickness, breadth, number of bolts, and bolt dimension.

7. The system of claim 1, wherein the trolley system needs to be entirely disconnected from the reaction forces of the trolley system in order to be used on the flange.

8. The system of claim 1, wherein the bolts from above by using at least two chains to join the wrench socket to the trolley system.

9. The system of claim 1, wherein the center of gravity of the trolley system is below the flange.

10. The system of claim 1, wherein the trolley system being adjusted to the size of an operator and the distance between a work platform and the flange.

11. The system of claim 1, wherein the trolley system is built so compactly that the system fits through all hatches.

12. The system of claim 1, wherein the trolley system is designed in such a way that partial or full automation is possible and the function of the trolley system being optimally coordinated through the use of gas springs and the right choice of articulation points.

13. The system of claim 1, further an elastic and plastic areas of the wrench socket are reached when the torque is increased and the wrench socket generates larger rotation angles.

14. The system of claim 1, wherein a delta between zero measurement before and after the tightening/loosening process has a minimal elongation, the detection of bolts is relatively straightforward.

15. The system of claim 12, wherein the trolley system is adapted to any of the flange diameters and sizes.

16. The system of claim 1, wherein the trolley system comprises a conical alignment pin at 12 and 6 o'clock for allowing easy alignment of the trolley system.

17. The system of claim 1, wherein the trolley system comprises a third portion of the body including a center of mass of trolley system, a mediated center of mass, a position of the bolts for hanging on a tower crane, or any foregoing combination.

18. The system of claim 15, wherein the third portion of the body is interlocked with the first and second portions of the body.

19. A method for automatically tightening tower segments in wind turbine, the method comprising:
configuring a body with a first portion and a second portion at either end, the first portion mounting close to bolts and driving on top of a flange while being guided by wheels, the second portion pushing against the interior of the tower through wheels to move the body around the flange to automatically tighten the flange;
attaching at least one wrench socket with or without internal pattern to a plate and each of the wrench socket is configured to tighten each bolt placed on top rather than the bottom through electric or hydraulic torquing and/or tensioning;
configuring a winch with a balancer to screwing the wrench socket with or without internal pattern for fastening each bolt to the nut, further a small fraction of elastic deformation is recovered after torque screwing as a portion of the torsion recovers;
moving a lever assembly while using springs up and down with negligible manual force and moving the trolley system from one bolt to next bolt; and
associating a generator to provide power for rotating the wrench socket for tightening the bolts through torquing and/or tensioning.

20. The method of claim 19, wherein the generator is one of manual, electric, pneumatic and/or hydraulic in nature.

21. The method of claim 19, wherein the generator is an hydraulic pump.

22. The method of claim 19, wherein a torque-to-angle of rotation ratio is continuously monitored by a sensor connected to the generator, when the gradient falls beyond the acceptable range, the generator shuts off.

23. The method of claim 19, wherein the center of gravity of the trolley system is below the flange.

24. The method of claim 19, wherein the weight of the trolley system being safely guided to the top of the flange.
